(19) United States
(12) Patent Application Publication
(10) Pub. No.: US 2005/0289018 A1
(43) Pub. Date: Dec. 29, 2005

(54) Online personalized apparel design and sales technology with associated manufacturing and fulfillment techniques and processes

(76) Inventors: Todd Sullivan, Wesley Chapel, FL (US); Gerardo Arturo Alas M., Santa Ana (SV); Elmer Antonio Morales Cortez, Nueva San Salvador (SV); Lavent Camlibel, Chesapeake, VA (US); Richard Risbridger, New Orleans, LA (US); Paul Sullivan, Wayland, MA (US); Sean Sullivan, Wesley Chapel, FL (US)

Correspondence Address: Burns & Levinson LLP, Suite 300, 1030 Fifteenth Street, N.W., Washington, DC, 20005-1501, US

(21) Appl. No.: 11/147,107

(22) Filed: Jun. 7, 2005

Related U.S. Application Data
(60) Provisional application No. 60/577,523, filed on Jun. 7, 2004.
(60) Provisional application No. 60/577,760, filed on Jun. 8, 2004.

(51) Int. Cl. G06Q 30/00

(52) U.S. Cl. 705/27; 705/26

(57) ABSTRACT

The present invention relates to systems and methods for the customized and personalized design of school, team, club, class and event branded apparel and merchandise online via dealer, client-branded and business-to-business websites without minimum orders. The invention further comprises customized design ordering, order fulfillment, image text positioning, image curing, image cutting, and pixilation methods.

### CROSS REFERENCE TO RELATED APPLICATIONS

This application claims priority under 35 U.S.C. § 119 from provisional application Ser. No. 60/577,523, filed Jun. 7, 2004, and entitled “Online Personalized Apparel Design and Sales Technology with Associated Manufacturing and Fulfillment Techniques and Processes”, and provisional application Ser. No. 60/577,760, filed Jun. 8, 2004, and entitled “Factory Automatic Order Processing”.

### FIELD OF THE INVENTION

This invention is related to the field of customized apparel and product design. More particularly, the invention is related to the selection and customized design of organization-specific apparel and products by a user via a website on the Internet.

### BACKGROUND OF THE INVENTION

The U.S. custom apparel marketplace is very large and extremely fragmented. Today there are over 24,000 printers supplying a market that is approximately $20B in size. High schools, middle schools and elementary schools account for approximately $2.3B in total spending each year on custom printed items. The majority of this niche market has traditionally been served by small “mom and pop” print shops of varying quality and reliability. Small print shops often provide good, personal design services but they can require large minimum orders (usually 12-24 items). These shops offer a limited product selection, reduced product customization and personalized printing options, and often have long lead times.

Primary research via numerous focus groups about school branded products shows that satisfaction levels today for these products and the purchase process are low. Pervasive problems include high minimum order quantities, poor purchase processes, poor design capabilities, and long lead times. These problems arise because customers have to go to local screen printing shops for custom apparel and the technology and processes that these shops use have inherent flaws. No reasonable alternative exists for the school market.

Local shops primarily use screen printing to fulfill custom orders. As the name implies, screen printing involves creating a screen for each design. Depending on the number of colors (1-4), a screen can cost $30-$125 to create. This fixed cost, along with other setup costs, must be allocated over the number of items printed, and therefore local shops usually require a minimum of 12-24 items be purchased for each design. Because of this, it is very expensive for customers to get personalized items, and instead each person on the team must wear exactly the same thing.

With the standard ordering process, there is a single purchaser for the whole team. This requires one person on the team to be in charge of the student vote for the product design, placing the order with the local shop, distributing the shirts to the team members, and collecting the money. During interviews, this purchase process was the most cited problem affecting customer satisfaction. Because of the screen printing process, designs are limited, in most cases, to a maximum of four colors per side, with each color after the first costing substantially more. This, along with a small artwork collection, limits the design capabilities at these shops. Because prices depend on the number of colors, number of sides printed, and number of items per order, estimating prices can be difficult for consumers.

U.S. Pat. No. 4,873,643 issued to Powell et al. is for the imprinting of stored designs. The system is interactive and the designs can be altered to suit the customer. However, while there is an ordering function, there is no scheduling and production control function. U.S. Pat. No. 6,344,853, issued to Knight, is directed to the superimposition of images to create a preferred logo and the like. The items can be ordered and scheduled, and are not necessarily garments.

U.S. Pat. No. 5,459,819, issued to Watkins et al., is directed to the custom imprinting of images, on mugs, garments, etc. The images can be made from the combination of a plurality of images. Ordering and management functions are not included.

Prior art systems also inhibit the user by requiring him or her to design the selected product in a series of pre-ordered steps. The user may not work on different parts of the customized design process in an order convenient to him or her, and is restricted to completing the design process in a defined order. This is prohibitive to the free-flowing creativity that is exhibited by users when designing personalized apparel.

The present invention is designed to address the lack of additional functionality discovered in the prior art, and combines a novel customized apparel design process with fulfillment capabilities such as ordering, management, and production-oriented processes. Users are not restricted in the order of the steps taken to complete the design and customization processes. The present invention also allows for the design and customization of products other than apparel, such as bags, mouse pads, towels, water bottles, stickers, coffee mugs, and cards, etc.

It is an object of the invention to provide customer personalization of an apparel and merchandise design.

It is another object of the invention to provide customer application of apparel designs to multiple garments, and merchandise.

It is another object of the invention to provide mechanisms for real-time design revision by a customer.

It is yet another object of the invention to provide mechanisms for the placement of customized apparel and merchandise orders.

Still another object of the invention is to provide processes for manufacturing and inventory control.

### SUMMARY OF THE INVENTION

The present invention relates to a system for the customized design of apparel and merchandise, said system comprising a website for the customization of apparel and merchandise image designs; a user accessing the website remotely through an internet connection; at least one screen interface on the website for the customization of apparel and merchandise image designs by the user; a library comprising a database containing a plurality of pre-designed images; at least one design tab on the at least one screen interface for selection by the user for the creation of customized design; at least one design layer included within the at least one screen interface; a host database for the storage of data pertaining to the customized apparel and merchandise designs; and a remote database for the storage of data pertaining to the customized apparel and merchandise designs.

An additional embodiment of the present invention relates to a system for the customized design of apparel and merchandise, said system comprising a website for the customization of apparel and merchandise image designs; a user accessing the website remotely through an internet connection; at least one screen interface on the website for the customization of apparel and merchandise image designs by the user; at least one design tab on the at least one screen interface for selection by the user for the creation of customized design; at least one design layer included within the at least one screen interface; a remote server having images of user-customized images for uploading; a host database for the storage of data pertaining to the customized apparel and merchandise designs; and a remote database for the storage of data pertaining to the customized apparel and merchandise designs.

The invention further relates to a method for the customized design of apparel and merchandise, said method comprising accessing of a website for the customized design of apparel and merchandise by the user; selecting a desired product for customized design; selecting an image template from a designated database library; alternatively uploading an image from a remote server; selecting a design layer; adding text to the selected or uploaded image template or image to create a customized design product; accepting the customized design product; displaying the customized design product; and purchasing the customized design product.

The invention also relates to a method for the fulfillment of customized design apparel and merchandise orders, said method comprising verifying ordering information provided by a user for the purchase of a customized product design; sending a record of an order to a host database; linking the order record into an order queue; preparing a web-ready image of the customized product design; uploading the web-ready image to a host database; creating a URL link to the web-ready image; embedding the URL link into an electronic mail message; sending the electronic mail message to the user; retrieving the order record from the order queue; sending the order record to at least one remote database; directing the order record to a file server; placing the order into a processing batch; completing processing of the batch; and shipping the order to the user.

The invention further relates to a system for the fulfillment of customized design apparel and merchandise orders, said system comprising at least one record of an order of a customized product design; an order queue for the linking of at least one order record; a web-ready image of the customized product design; a URL link of the web-ready image; a host database having at least one order record; a remote database having at least one order record; and a processing batch having at least one order record.

The invention further relates to a method for positioning image text on customized apparel and merchandise designs, said method comprising enlarging customized product images and text to substantially occupy a printing area; adding subsequent customized product images and text to the printing area; and proportionately downsizing the previously added customized product images and text to accommodate the subsequently added customized product images and text in the printing area.

The invention also includes a method for the pixilation of customized apparel and merchandise designs, said method comprising adding a substantially box-shaped border to at least one customized product design image to create at least one contoured image; displaying the at least one contoured image in at least one layer; maintaining the quality of the at least one contoured image within the at least one layer; and optionally dithering the at least one contoured image.

The invention also relates to a method for the fulfillment of customized design apparel and merchandise orders, said method comprising generating and downloading an order file; generating and downloading customized product design images associated with an order file; generating order reports; sending the order reports to a designated location; performing an error check of the order reports; assigning at least one order file to a batch; classifying the at least one order file by priority; sending the electronic mail message to the user; auditing the customized product design images; printing the customized product design images; performing a first scan of the customized product design images; preparing transport documents for the shipping of a completed customized product design; curing the customized product design images; cutting the customized product design images; transferring the customized product design image to a user-selected product to create the completed customized product design; optionally adding hand tags to the completed customized product design; and performing a process quality control.

The system presents the required order forms to the customer, including images, size and color ranges, and available designs that can be applied to the apparel and merchandise. The customer can select from the available ranges, or vary them as desired, or create designs to be placed on the apparel and merchandise (symbols, insignia, indicia, etc.) The customer can “see” on the screen the results of the selections and their variations. After completing the choices, the customer can then place the order(s) with dates, quantities, sizes, etc. The supplier can then schedule the manufacturing to minimize the inventory (“just in time”) and confirm the deliveries, prices, and schedules. The supplier can use the customized designs on other products and offer them to the customer(s) as desired.

The user of the system also selects from other variables, such as type of garment and merchandise (T-shirt, sweat shirt, sweater, jacket, skirt, bags, mouse pads, towels, water bottles, stickers, coffee mugs, cards, etc.) size, color and style. The user can also request the quantities, delivery schedules and addresses, and perhaps other factors such as packaging.

### BRIEF DESCRIPTION OF THE DRAWINGS

FIG. 1 is an example of a screen interface presented to a user for ordering personalized apparel and products in which design and ordering tabs and depictions of the personalized products are displayed to the user.

FIG. 2 is an example of a crew neck t-shirt containing personalized apparel design in accordance with the present invention.

FIG. 3 is an example of a coffee mug containing personalized or customized product design in accordance with the present invention.

FIG. 4 is an illustration of the front and back of a personalized or customized t-shirt as displayed to the user in accordance with the present invention.

FIG. 5 is a depiction of the ordering and fulfillment processes of the present invention.

FIG. 6A is a component of a flow chart depicting the selection, customization, and order process that a user completes in accordance with the present invention.

FIG. 6B is a second component of a flow chart depicting the selection, customization, and order process that a user completes in accordance with the present invention.

FIG. 6C is a third component of a flow chart depicting the selection, customization, and order process that a user completes in accordance with the present invention.

FIG. 6D is a fourth component of a flow chart depicting the selection, customization, and order process that a user completes in accordance with the present invention.

FIG. 6E is a fifth component of a flow chart depicting the selection, customization, and order process that a user completes in accordance with the present invention.

FIG. 7 is an example of a screen interface presented to a user for the selection of text color and font for the personalized or customized apparel or product design, as in accordance with the present invention.

FIG. 8 is a second example of a screen interface presented to a user for the selection of text color and font for the personalized or customized apparel or product design, as in accordance with the present invention.

FIG. 9 is an additional example of a screen interface presented to a user for designing, viewing, and ordering personalized apparel as in accordance with the present invention.

FIG. 10 is another screen interface presented to a user for image designing, viewing, and ordering of personalized apparel as in accordance with the present invention.

FIG. 11 is another example of a screen interface presented to a user for image designing, viewing, and ordering of personalized apparel as in accordance with the present invention.

FIG. 12 is an example of the screen shot interface presented in FIG. 9 with an optional location for the shopping cart containing the user's personalized design order.

FIG. 13 is yet another example of a screen interface presented to a user for image designing, viewing, and ordering of personalized apparel as in accordance with the present invention.

FIG. 14 is an example of a screen interface for MyGarb.com in which the customer is presented with product selection, product design and ordering options for the customization of personalized apparel in accordance with the present invention.

FIG. 15A is a component of a flow chart depicting the process for the creation of images for university and school customized apparel in accordance with the present invention.

FIG. 15B is a second component of a flow chart depicting the process for the creation of images for university and school customized apparel in accordance with the present invention.

FIG. 15C is a third component of a flow chart depicting the process for the creation of images for university and school customized apparel in accordance with the present invention.

FIG. 15D is a fourth component of a flow chart depicting the process for the creation of images for university and school customized apparel in accordance with the present invention.

FIG. 16A is a component of a flow chart depicting the fulfillment process for the production of the personalized apparel in accordance with the present invention.

FIG. 16B is a second component of a flow chart depicting the fulfillment process for the production of the personalized apparel in accordance with the present invention.

FIG. 17A is a component of a flow chart depicting the printing process for the personalized apparel images in accordance with the present invention.

FIG. 17B is a second component of a flow chart depicting the printing process for the personalized apparel images in accordance with the present invention.

FIG. 18 is a flow chart depicting the document preparation process for the transport of the completed personalized apparel and products in accordance with the present invention.

FIG. 19A is a component of a flow chart depicting the production and quality control processes for the personalized apparel design in accordance with the present invention.

FIG. 19B is a second component of a flow chart depicting the production and quality control processes for the personalized apparel design in accordance with the present invention.

FIG. 19C is a third component of a flow chart depicting the production and quality control processes for the personalized apparel design in accordance with the present invention.

FIG. 19D is a fourth component of a flow chart depicting the production and quality control processes for the personalized apparel design in accordance with the present invention.

FIG. 20A is a component of a flow chart depicting the shipping and commercial invoice preparation for the personalized apparel design in accordance with the present invention.

FIG. 20B is a second component of a flow chart depicting the shipping and commercial invoice preparation for the personalized apparel design in accordance with the present invention.

FIG. 20C is a third component of a flow chart depicting the shipping and commercial invoice preparation for the personalized apparel design in accordance with the present invention.

### DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Therefore, specific structural, methodical and functional details disclosed herein are not to be interpreted as limiting, but merely as a basis for the claims and as a representative basis for teaching one skilled in the art to variously employ the present invention in virtually any appropriately detailed design.

First, products can be sold directly to consumers via internet websites. This is the traditional online sales avenue except the products and the printing is designed, customized, and/or personalized by the consumer through unique online tools and activities provided by the present invention. These unique online tools and activities can be either design or code oriented or both. One example is a one click design adaptation process where a customer can create a design on a specific product and with one click, see how that design looks on a different product with different design constraints.

A second example is the inventive system and process described herein for creating team or group products. The inventive system and process allows a customer to create a design on a product and then replicate the common elements of the design across multiple products for a multiple item order. The inventive system allows the customer to personalize each item with text and/or images in this multiple item order. Both of these allow customers to save a significant amount of time in creating the personalized/customized product and order that they require. In both cases, the design phase only occurs one and that design can be used to display a similar and compatible design on different products or used to create multiple products without redesigning the common design components.

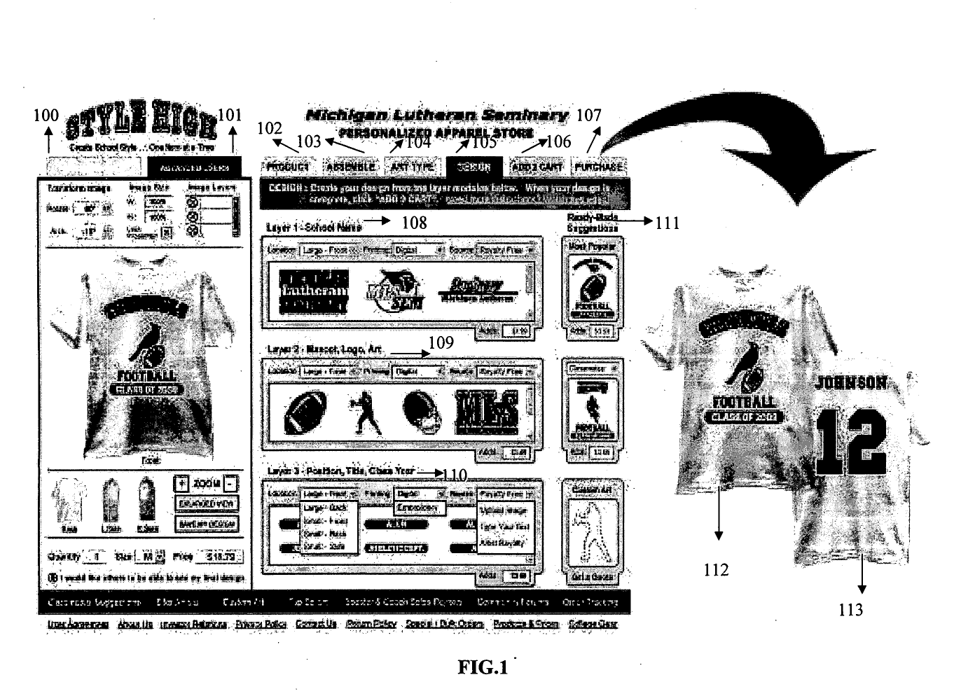

FIG. 1 provides an example of an interface presented to a user affiliated with Michigan Lutheran Seminary, for example, as the user is accessing a web site on which the personalized or customized apparel may be designed and ordered via. My Garb.com is an example of a website providing such a service. As set forth in FIG. 1, the interface presented to the user contains various tabs which may be selected by the user to configure the selected design. Tab 100 allows the user to select a basic design process. The user selects tab 101 to implement the advanced design components of the invention. Tab 102 is selected by the user to choose the product (e.g. t-shirt, crew shirt, sweatshirt, coffee mug, etc.) on which he or she wishes to place the customized design. Tab 103 is selected by the user to assemble variable components of the product. Via tab 104, the user may select the art type for the design implementation.

On the design tab 105, which is depicted in the right half of FIG. 1, the user is presented with various layers through which the design process may be completed. Design layer 108 presents various logos depicting an organization's name, in this case a school name, among which the user may select a preferred choice. Once the name logo is selected, the user moves to design layer 109, in which the user may choose from illustrations of a team mascot, logo or other artwork for implementation onto the apparel design. In design layer 110, the user can place a team position, title or class year onto the apparel design.

Design tab 106 allows the user to add the assembled products to a cart for checkout. Final purchase of the product may be performed through the selection of design tab 107.

Ready-made suggestions 111 for the design are presented to user for a variety of design options. The user may choose among the options or he or she may customize the apparel in any way he or she chooses. The ready-made suggestions are not limited to, but may include the most popular design selection placed by customers using the site.

As the user is selecting the design options among the various layers, the user may view in real-time the placement of the selected design options on the front 112 and back 113 of the customized apparel.

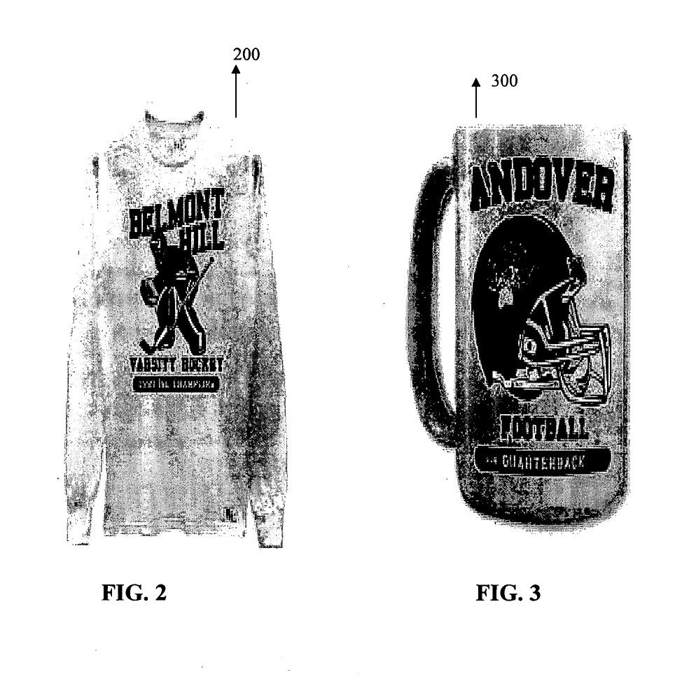

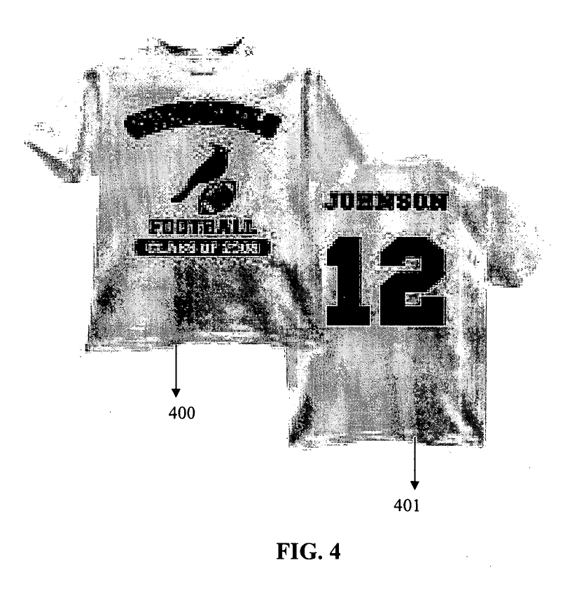

FIG. 2 shows an example of a crew neck T-shirt 200 designed in accordance with the present invention. FIG. 3 depicts a coffee mug 300, also designed in accordance with the system and methods provided herein. FIG. 4 illustrates the front 400 and back 401 of a crew neck T-shirt designed in accordance with the invention. This is similarly depicted as features 112 and 113 in FIG. 1.

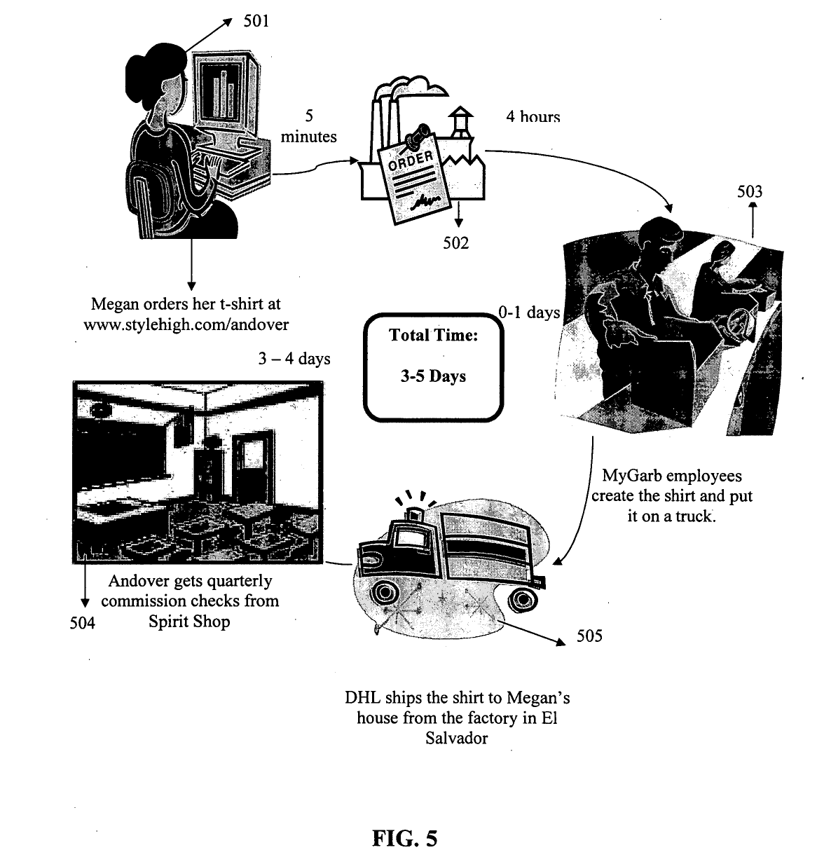

FIG. 5 illustrates an approximate timeline for the ordering, production and shipping of a customized apparel design to a user in accordance with the present invention. It is estimated that Megan 501, an example of a client user, may design and order a customized T-shirt at a website, www.stylehigh.com/andover, in approximately five minutes. Disbursement of the order at a design factory 502 to factory workers is estimated to be completed in approximately 4 hours. Within 1 day, the factory workers 503 can create Megan's shirt and place it on a truck for transport. For example, a DHL truck 504 can deliver the shirt to Megan's house. The cycle depicted in FIG. 5 is completed when Megan's school, Andover, receives a quarterly commission from the website provider.

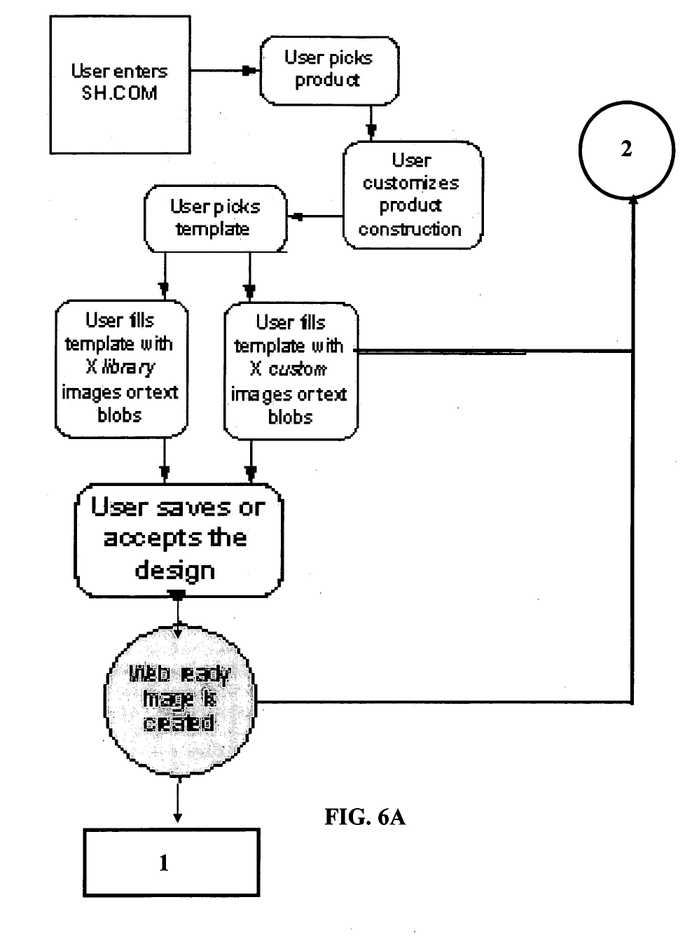

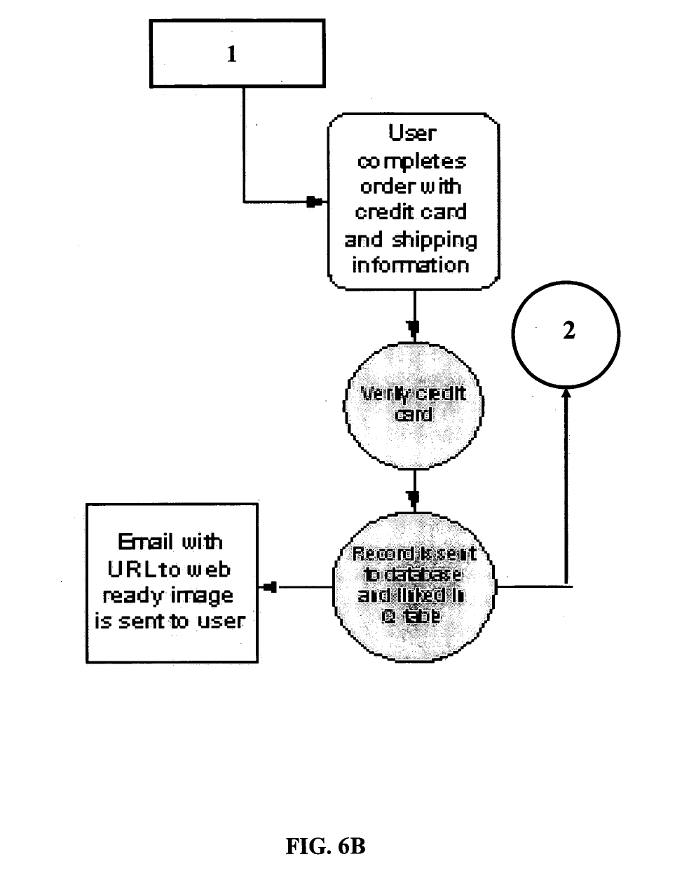

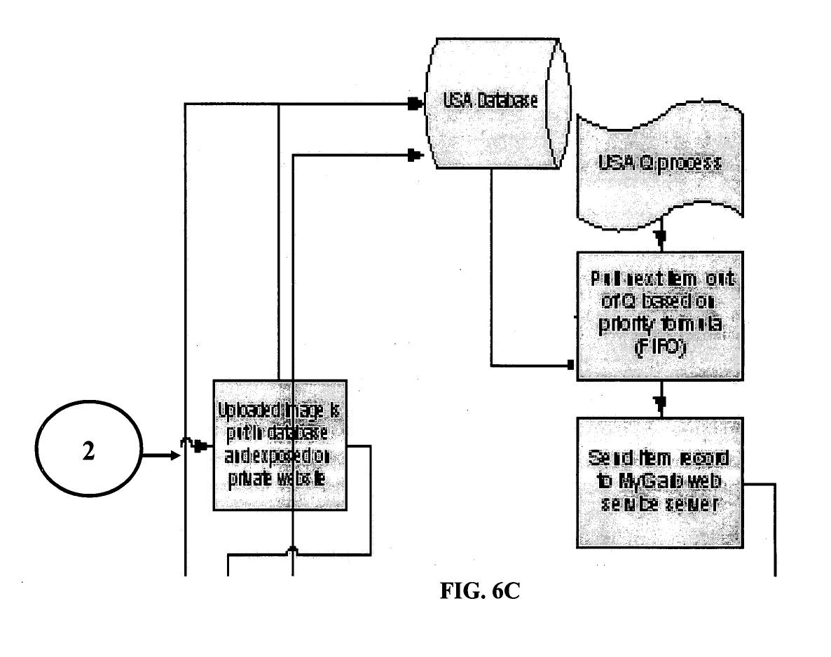

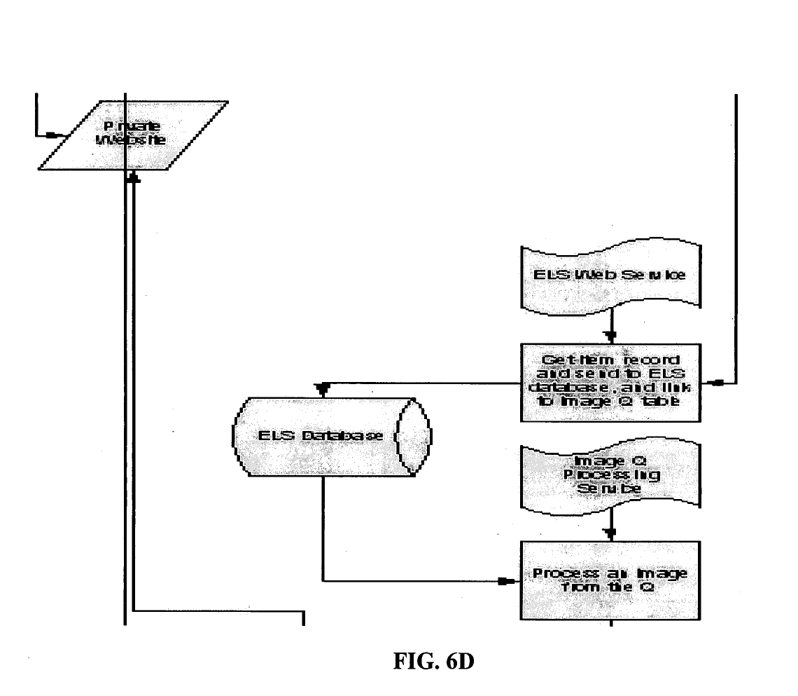

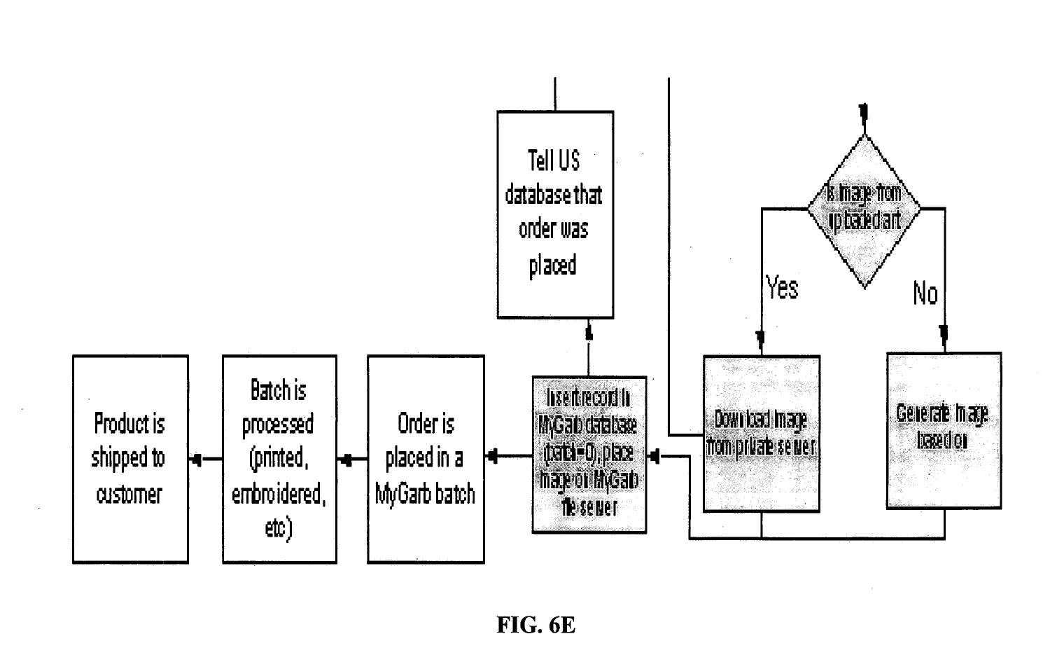

The ordering process is detailed in the flow chart provided in FIGS. 6A through 6E. A user, such as Megan, signs onto a website. The user picks the product (e.g. T-shirt, sweatshirt, coffee mug, bag, etc.) that he or she wishes to purchase. The user customized the product construction, as detailed further below. The user picks a template, which the user files with images from a designated database library or text blobs. Alternatively, the user may upload his or her own custom images to the website and may add text blogs. The user then saves or accepts the design. An image of the product, for example the front 400 and back 401 of a crew-neck T-shirt in FIG. 4, is created for viewing by the user. The user completes the order by providing pertinent credit card and shipping information. The system verifies the authenticity of the credit card. A record of the transaction is sent to the system's database and linked in a queue. An email with a URL link to the web-ready image is sent to the user.

FIGS. 6C through 6E depict the remainder of the fulfillment processes for completing the apparel design order. Specifically, these figures detail the steps for the second section (marked “2”) of the order fulfillment sequence. Once the user fills the template with the database library-derived or user-customized images, the uploaded image is places into a database and exposed on a separate website. The image is then sent to a private website. This website is viewed by the user via the link embedded in the user's confirmation email.

The embodiment depicted in FIGS. 6A through 6E is implemented when the system databases are stored in one location, for example, the United States, and the order fulfillment is processed in another location, e.g. a factory located offshore. The details of FIGS. 6A through 6E are customized for this scenario, however, obvious variants of this procedure are within the scope of the present invention.

The user's purchase order and the uploaded images are directed to USA database. Items are pulled out of the queue table stored within the database on a priority basis. The pulled item record is directed to the web service server for further processing. FIG. 6D shows the pulled item as it is directed to an offshore web service. The item record is sent to an offshore database and linked to an image queue table. From the offshore database, the item is processed from the queue.

If the image contains uploaded art, the image is downloaded from the private server (i.e. the user's server) on which the image was stored. This step is depicted in FIG. 6E. The downloaded image may be directed in one of two ways. First, the image may be sent to the private website for viewing by the user within the URL link in his or her confirmation email. Secondly, the image is directed onto a file server. The file server also directed the incoming information in two ways.

First, the record of the order is inserted into the database for the host website. This host database communicates to the USA database to inform that the order was placed. Secondly, the order is placed into batch. The batch is then processed (e.g. printed, embroidered, etc.). Once the batch processing is complete the product is shipped to the customer.

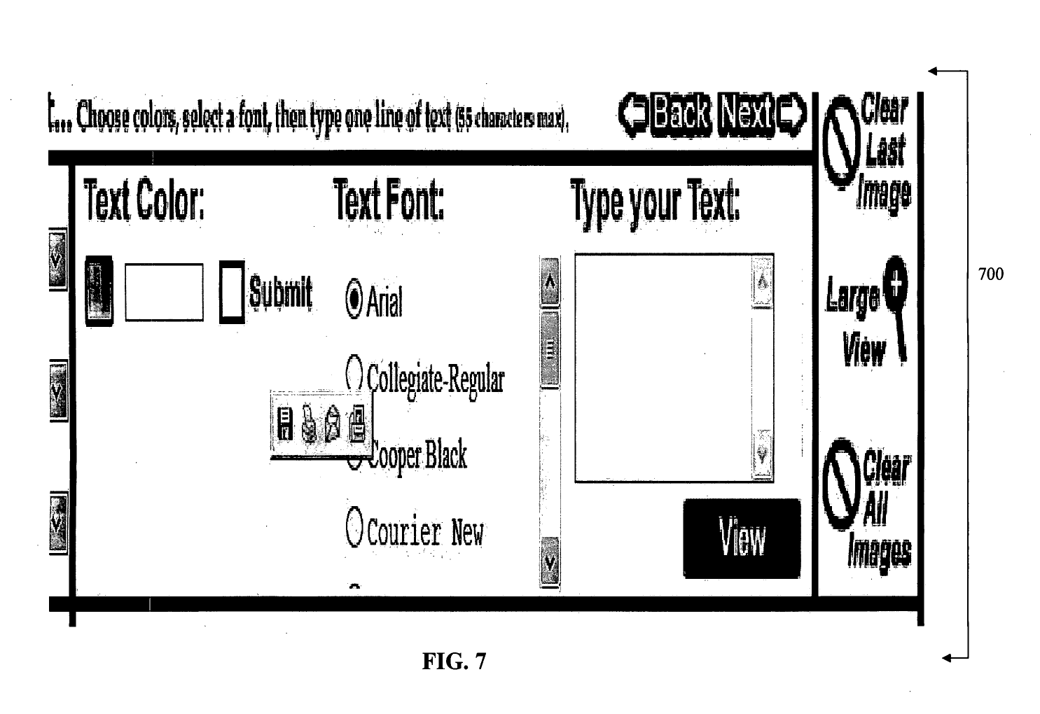

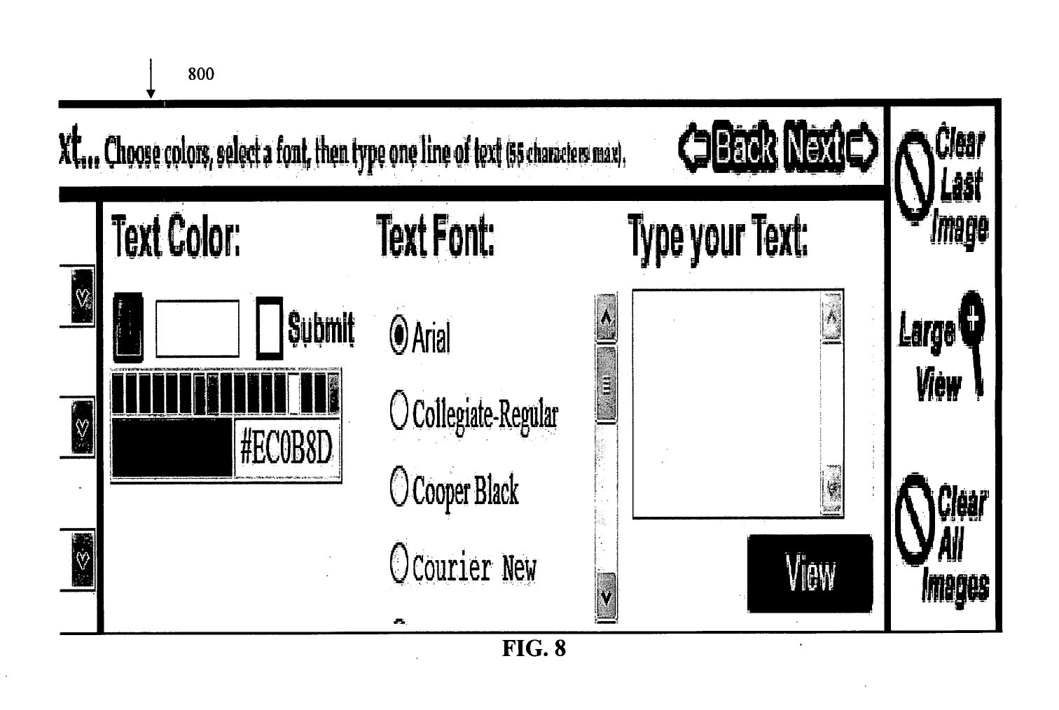

Further detail of the ordering interfaces are presented in FIGS. 7 and 8. FIGS. 7 and 8 provide alternate examples of text formatting screens that may be presented to a user during the customized design process. In each of these text formatting screens, the user may select a text color and a text font (e.g. Arial, Collegiate-Regular, Cooper Black, Courier New, etc.). The user may scroll down the screen to view all available text fonts. Once the text formatting selections are made, the user inputs the desired text for implementation onto the apparel design. The user then clicks the view button to see the entire customized design. The user may opt to view a large view. The user may opt to clear the last image that was inserted into the design. The user may also clear all images inserted into the design, and start the design customization process from the beginning. FIG. 8 provides additional colors selection for the user's choosing.

The system and methods described herein may be used to sell apparel and products to consumers through client-branded internet web applications or interfaces developed for My Garb clients, as illustrated in FIGS. 1, 11, and 13. This allows the fulfillment of sales directly to a more targeted end consumer. Because the inventive system and methods give clients full or partial access to the design criteria, constraints and possibilities, clients can customize the offering to their end consumer as they see fit. This kind of participation on the part of the client allows for further personalization of the product offering to suit the needs of its clients' internet community. By creating client-branded internet web applications accessible through client-managed internet sites, marketing directly to the end consumer can be more targeted and can be less expensive to acquire a customer. Therefore, this business can be lower cost and create higher margins than traditional online commerce-oriented web sites.

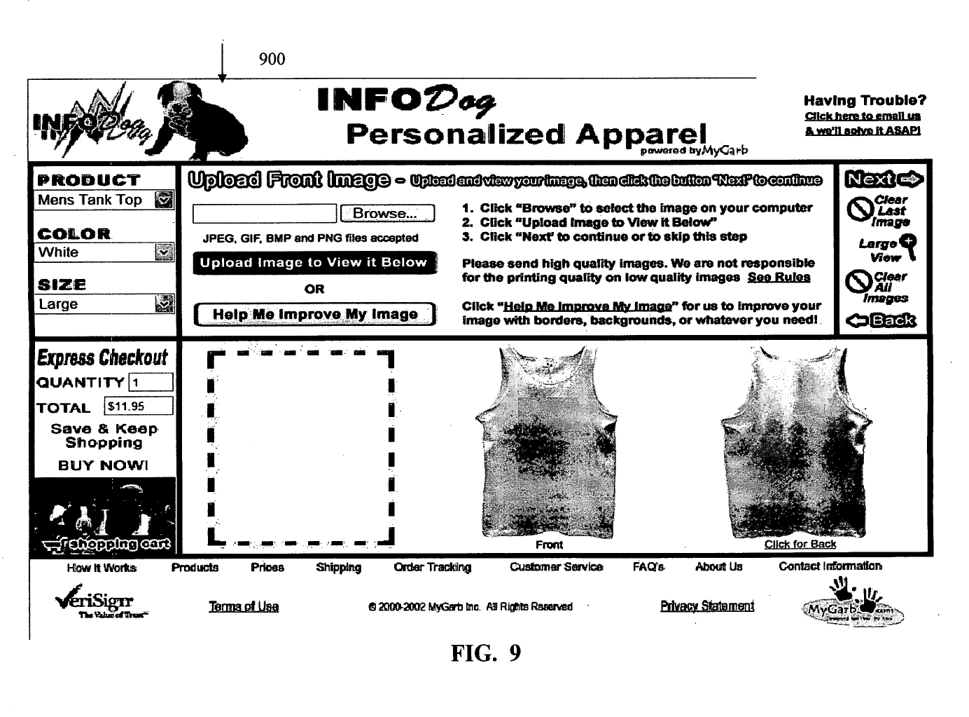

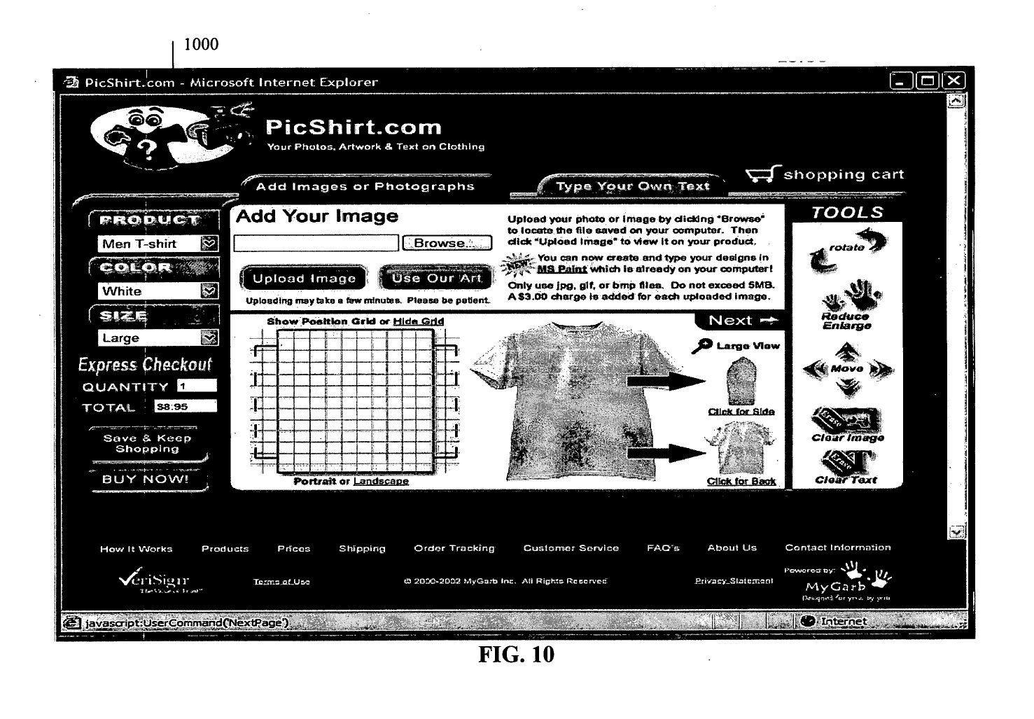

The system and methods of the present invention may also be implemented to sell products directly to clients or retailers through business to business internet commerce applications. This is depicted in FIGS. 9, 10 and 12. This is the answer to just-in-time inventory concerns. Retailers have always had to monitor their inventory levels to keep track of how much capital they have tied up in inventory. When capital is tied up in inventory, the inventory becomes a cost to the retailer. Although it is an asset, it is a depreciating one. The present invention solves this inventory dilemma by allowing inventory to be replenished in as small as quantity as the retailer wants. Traditionally, the retailer needs to order in high volume from other suppliers in order for those suppliers to manufacture and ship product but with My Garb a retailer can order as few as a single unit of any product and have it delivered in days instead of weeks.

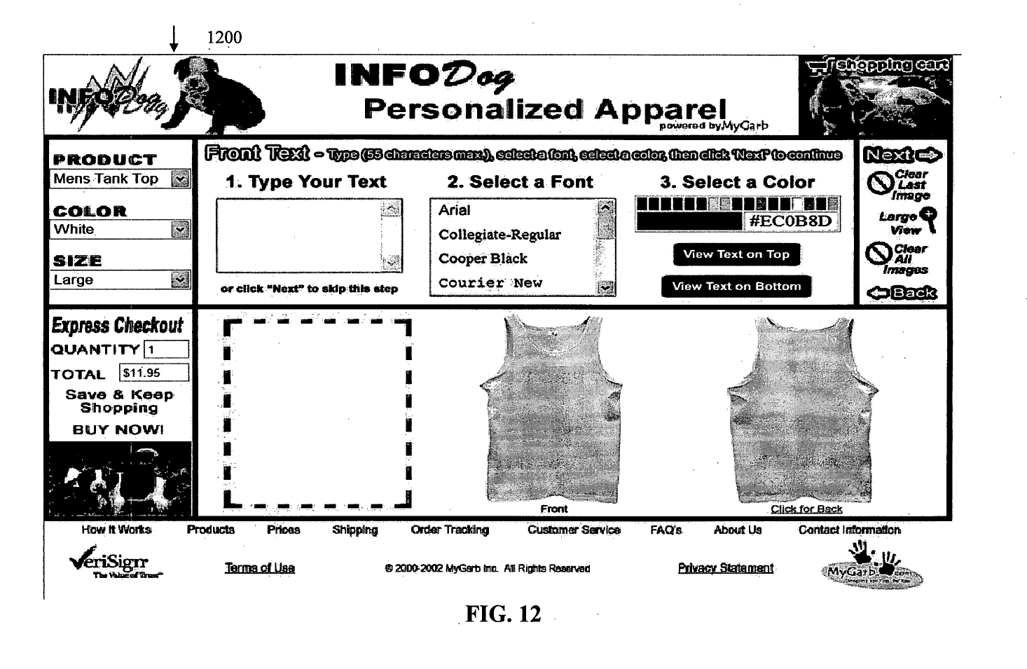

FIG. 9 provides an example of a web interface provided by InfoDog for personalized apparel design. Therein, the user uploads an image to the website for placement onto a selected product (e.g. a men's tank top) in a selected color (e.g. white) and size (e.g. large). The components described in the screen interfaces above are provided herein. The quantity of items and total cost are presented to the user. This allows a user to order as little as one item, or as many items as he or she prefers. A similar interface is presented in FIG. 10 from PicShirt.com, and in FIG. 12 from InfoDog.

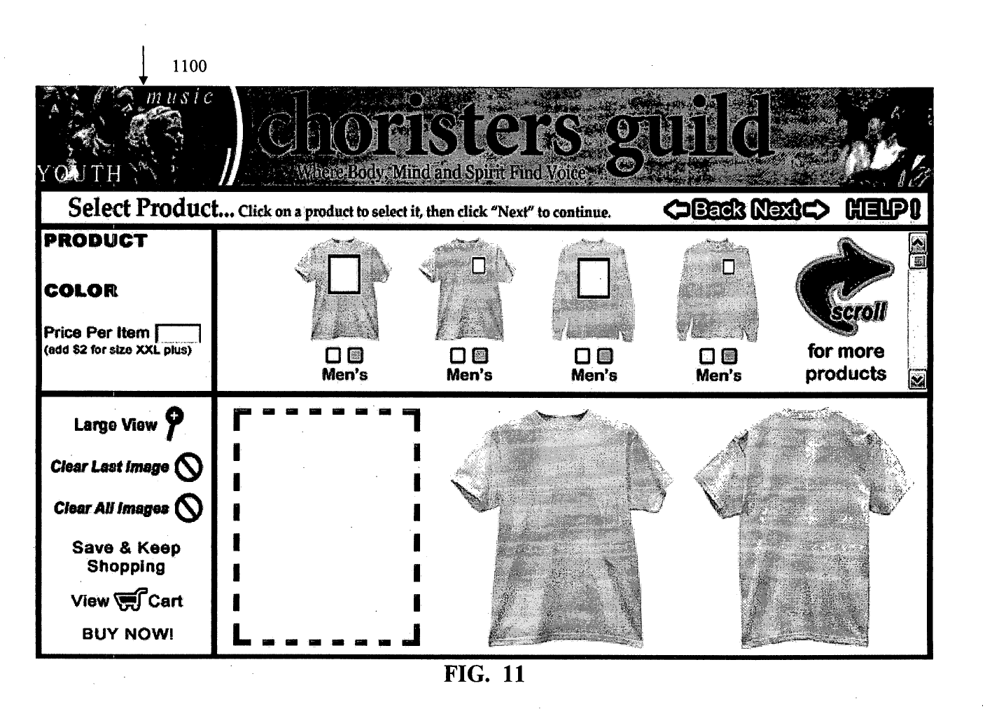

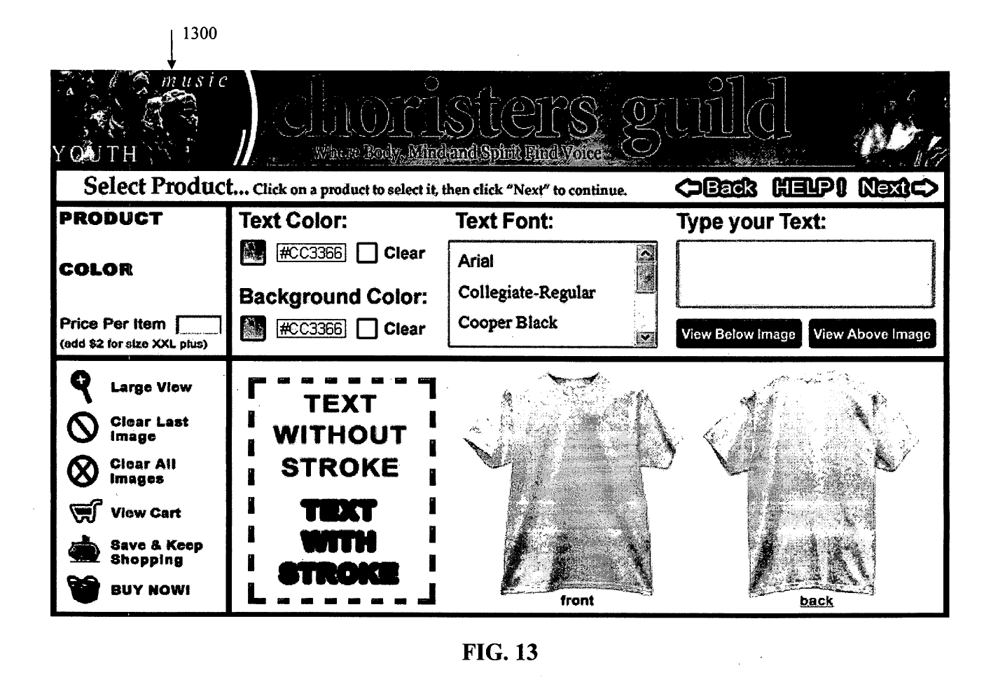

FIGS. 11 and 13 provide examples of screen shot interfaces presented to users who are customizing and order apparel from a client-branded website. An organization, for example, Choristers Guild, can implement the system described herein on its own website as aforementioned. In FIG. 11, the user is presented with a selection of items (e.g. men's short sleeve T-shirt, men's long sleeve T-shirt), with options for the location of the desired image placement. This allows client organization to allow their members or users to obtain customized apparel within style boundaries chosen by the organization. As depicted on the right side of the screen in FIG. 12, the user may scroll down for more product options. Images of the front and back of the selected product are displayed to the user.

FIG. 13 illustrates the customized design selections available to the user, similar to the interfaces described above. The user may view the inputted text characters with or without stroke, as seen in the bottom left portion of FIG. 13.

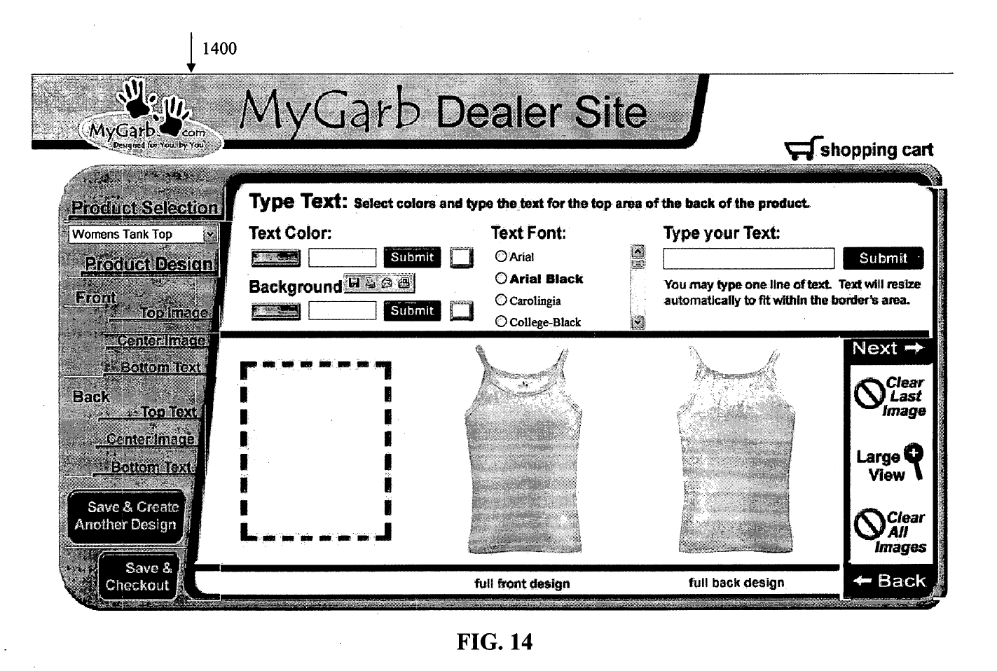

FIG. 14 provides an example of the screen shot interface presented on the dealer site of MyGarb.com. The components of the screen interfaces described above are replicated herein. All of the interfaces described heretofore depict various embodiments for the implementation of the present invention.

The inventory replenishment system of the present invention allows a retailer to personalize the items in inventory as well which allows each retailer to differentiate their offerings accordingly, as described above. This is a feature that would cost significantly more if it were available from traditional suppliers. Using the inventive inventory replenishment technology and process, each retailer is able to respond to changes in trends, seasons, growth and customer demand. The retailer can do all of this less expensively and more quickly than through traditional supplier/retailer channels.

As referenced herein, the system of the present invention allows a customer to indiscriminately design on the front, back, and sides (any separate location) of a product regardless of where the customer is in the design phase. This is unique because on other design oriented websites, there is an order in which a customer must complete the process. Although a customer may begin the design process at different stages of the process with other retailers, a customer is not able to easily change the order of the design process as the present invention offers. This flexibility allows a customer to go directly to the area on which they wish to design or choose different tools to use in the design process at any time.

At any time, a customer can then change the design location and continue designing on their product while maintaining and viewing their previously designed work on different product locations. At any time, the customer may change the size, color and/or product being designed while maintaining the design elements which will be automatically applied to the newly selected product. If the design constraints of the new product are different (i.e. they cannot accommodate the customer's selected design), then the technology will make the necessary adjustments to the customer's design to allow it to be compatible with the new product. A database associates images which are available with only certain products with complimenting images for all other products. In the event that a user changes the product and the selected images are no longer available, the database retrieve and replaces said images with the compatible and newly associated images.

The system of the present invention is able to provide this capability because of its flexibility in the design architecture and the coding of its web applications/internet sites. Prior art systems and existing competitor systems that allow online apparel design or product design are not able to allow the customer to decide on the order of processes in which a customer takes to create the final product or design(s). Therefore, the invention offers a more flexible, convenient, user-friendly, and faster online design process than is currently available in the market.

Image Text Positioning

The system of the present invention presents a way for an online/web image or text to automatically change its original position and size on a product based on an additional text or image being selected and added to a new desired size and location. The system of the present invention accurately presents the size and location of the printing on a product that was not previously available. Without this feature, web images may not reflect their size and positioning accurately and therefore the user does not know exactly what he or she is buying. Secondly, by having the size and location of previous images and/or text, the system of the present invention displays and offers aesthetically pleasing designs without the need of customer manipulation.

In the preferred embodiment of the present invention, the customized apparel design process is completed through a license to a patent-pending digital printing and embroidery technology, called DigiBright™. DigiBright™ allows the printing of high quality items at a fraction of the cost of existing printing technologies. This proprietary technology works by taking a combination of digital images selected or generated by a customer on the web, creating a single printable file, and then using proprietary software, adapted hardware, and a pioneering, automated business process to either sew, embroider, or fuse the art to each product. Further description of the DigiBright™ technology is set forth in U.S. patent Ser. No. 10/995,811, which is hereby fully incorporated in the instant application by reference.

In one embodiment, each printing area on a product is restricted to equal or less than approximately 12 inches by approximately 12 inches of space. Within this area, images and/or text are enlarged proportionally to their original dimensions in order to occupy as much of the available printing area as possible and be located in an aesthetically pleasing location. As subsequent images and/or text are added, the previous images and/or text are proportionally down sized and moved to accommodate the subsequent images and/or text within the restricted area. The resizing and repositioning is done so that each image and/or text layer does not overlap or interfere with the previous ones. This automatic adjustment of size and location is not currently available on the Internet, the present invention presents the processes to offer such improvements.

In another embodiment, each printing area on a product is restricted to equal or less than approximately 8.5 inches by approximately 11 inches of space. Within this area, images and/or text are enlarged proportionally to their original dimensions in order to occupy as much of the available printing area as possible and be located in an aesthetically pleasing location. As subsequent images and/or text are added, the previous images and/or text are proportionally down sized and moved to accommodate the subsequent images and/or text within the restricted area. The resizing and repositioning is done so that each image and/or text layer does not overlap or interfere with the previous ones. This automatic adjustment of size and location is not currently available on the Internet, the present invention presents the processes to offer such improvements.

In yet another embodiment, each printing area on a product is restricted to equal or less than approximately 8.25 inches by approximately 10.25 inches of space. Within this area, images and/or text are enlarged proportionally to their original dimensions in order to occupy as much of the available printing area as possible and be located in an aesthetically pleasing location. As subsequent images and/or text are added, the previous images and/or text are proportionally down sized and moved to accommodate the subsequent images and/or text within the restricted area. The resizing and repositioning is done so that each image and/or text layer does not overlap or interfere with the previous ones. This automatic adjustment of size and location is not currently available on the Internet, the present invention presents the processes to offer such improvements.

In an additional embodiment, each printing area on a product is restricted to equal or less than approximately 8 inches by approximately 10 inches of space. Within this area, images and/or text are enlarged proportionally to their original dimensions in order to occupy as much of the available printing area as possible and be located in an aesthetically pleasing location. As subsequent images and/or text are added, the previous images and/or text are proportionally down sized and moved to accommodate the subsequent images and/or text within the restricted area. The resizing and repositioning is done so that each image and/or text layer does not overlap or interfere with the previous ones. This automatic adjustment of size and location is not currently available on the Internet, the present invention presents the processes to offer such improvements.

In a fifth embodiment, each printing area on a product is restricted to equal or less than approximately 4 inches by approximately 5 inches of space. Within this area, images and/or text are enlarged proportionally to their original dimensions in order to occupy as much of the available printing area as possible and be located in an aesthetically pleasing location. As subsequent images and/or text are added, the previous images and/or text are proportionally down sized and moved to accommodate the subsequent images and/or text within the restricted area. The resizing and repositioning is done so that each image and/or text layer does not overlap or interfere with the previous ones. This automatic adjustment of size and location is not currently available on the Internet, the present invention presents the processes to offer such improvements.

In a sixth embodiment, each printing area on a product is restricted to equal or less than approximately 5 inches by approximately 3.75 inches of space. Within this area, images and/or text are enlarged proportionally to their original dimensions in order to occupy as much of the available printing area as possible and be located in an aesthetically pleasing location. As subsequent images and/or text are added, the previous images and/or text are proportionally down sized and moved to accommodate the subsequent images and/or text within the restricted area. The resizing and repositioning is done so that each image and/or text layer does not overlap or interfere with the previous ones. This automatic adjustment of size and location is not currently available on the Internet, the present invention presents the processes to offer such improvements.

In a seventh embodiment, each printing area on a product is restricted to equal or less than approximately 11 inches by approximately 17 inches of space. Within this area, images and/or text are enlarged proportionally to their original dimensions in order to occupy as much of the available printing area as possible and be located in an aesthetically pleasing location. As subsequent images and/or text are added, the previous images and/or text are proportionally down-sized and moved to accommodate the subsequent images and/or text within the restricted area. The resizing and repositioning is done so that each image and/or text layer does not overlap or interfere with the previous ones. This automatic adjustment of size and location is not currently available on the Internet, the present invention presents the processes to offer such improvements.

The following steps are included as part of the inventive process of creating an aesthetically pleasing design and maximizing the size of a consumer created design within a given print area.

First the customer chooses, uploads or types graphics or text which is displayed as large as the print area and image resolution (uploaded images only) will allow. The image resolution for images on client-branded websites are generally set within the control of the client-branded website administrator. If and when the customer choose to select, upload or type subsequent images, graphics and/or text, then the previously uploaded, typed or selected images and/or text adjust their size and positioning to accommodate the subsequent images, graphics and/or text so as not to overlap with the previous images, graphics and/or text and to enhance the overall aesthetics of the design.

The order of the images, graphics, and/or text may dictate the relative location and size of each selected, uploaded or typed image, graphic and/or text. As each image, graphic, and or text is selected, uploaded or typed, the spacing between subsequent images, graphics, or text is automatically determined as well. The spacing can be a pre-established distance determined by the code or it can be derived by the relative and/or adjusted size of each image, graphic or text present in each design.

Pixilation:

The present invention further comprises a process of disguising the white pixilated dots that generally accompany an overlaid image. When .jpg and .gif images are treated as layers, there are typically randomly assigned pixels on the outside of these images. These unwanted pixels disrupt the quality of the overall design as seen from the web. The inventive process reduces the negative impact that the traditional pixilation process has.

First, the process includes the creation of each image with a colored box-shaped border. Pixilation does not occur when the borders of an image are straight. Therefore, a square-shaped border around the image that matches the color of the underlying layer can create the desired effect. The result is process of clearly displaying contoured images as layers on the web without interrupting the quality of the top or underlying image.

Secondly, using image editing tools similar to those included in Adobe PhotoShop such as the dither feature can minimize pixilation but also may reduce image quality. A fine balance of image quality and reduced pixilation can produce a satisfactory result.

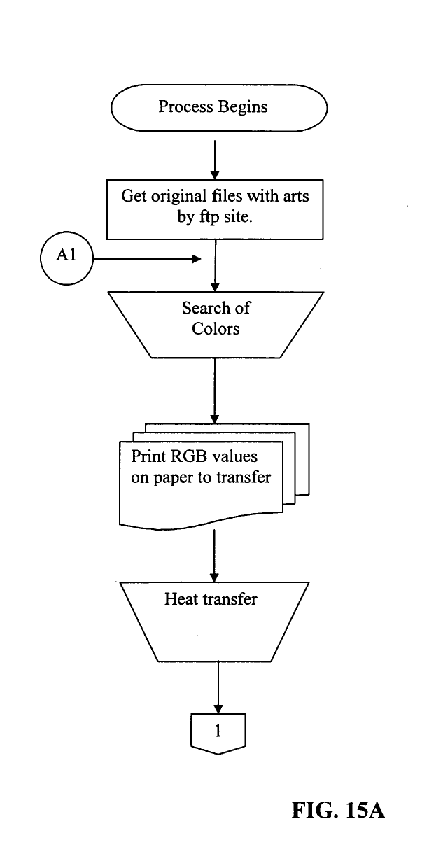

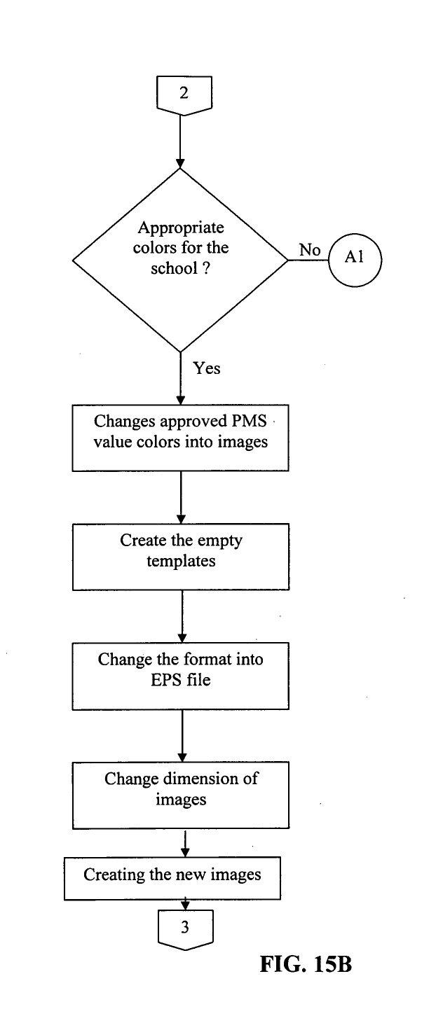

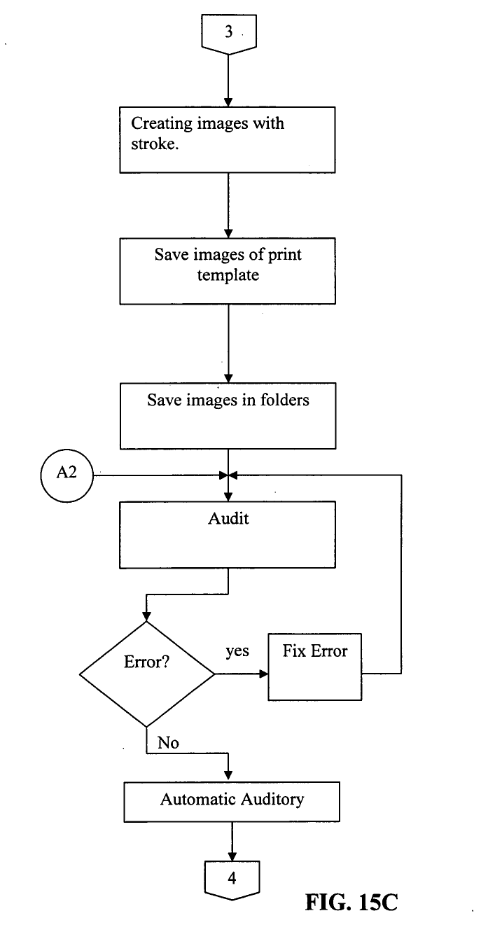

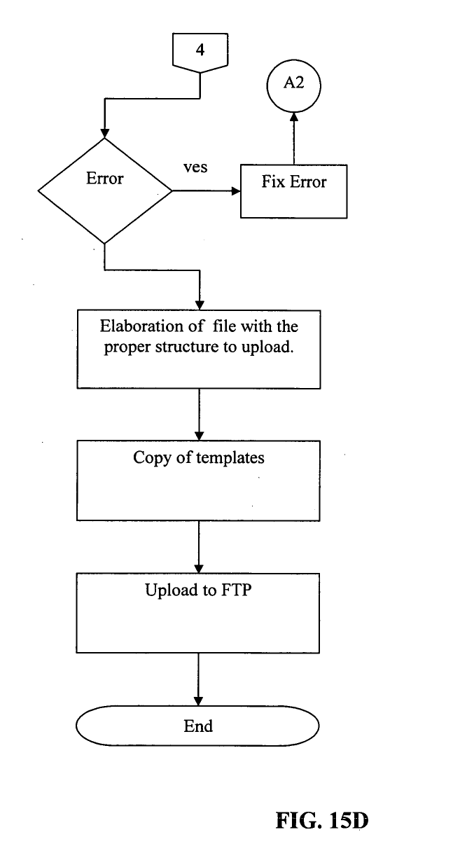

For client-branded websites, such a school and university websites, the methods of the present invention for Creation of different types of images for the School websites are set forth in FIGS. 15A through 15 A. Commencing with FIG. 15 A, the process begins through a download from File Transfer Protocol (FTP) files with original art. FTP is a standard method for sending files from one computer to another on TCP/IP networks such as the Internet. FTP is also the name of the command used to initiate transfer of files, as set forth above. Next, the system searches for required colors. The Pantone® guide of School PMS values from Pantone, Inc. of Caldstadt, N.J. is used and compared with Pantone's ProfilerPLUS RGB. Next, an administrative user prints selected colors on the Pantone® guide to create a sample image. ProfilerPLUS RGB is an Adobe® Photoshop® plug-in which creates custom RGB printer profiles for a wide range of color printers, papers and inks. It creates ICC compliant color profiles on Windows® and Macintosh for either platform.

A sample image is stamped and transferred on fabric or paper. Visual inspection of stamped fabric or paper as compared with the Pantone® guide is performed to make sure if the colors on the stamped fabric are the correct colors required by the school or university. As illustrated in FIG. 15B, if the colors are appropriate, the system changes the approved PMS value colors into images with an Encapsulated PostScript file (EPS). EPS is a standard file format for importing and exporting PostScript files. It is usually a single page PostScript program that describes an illustration or entire page. The purpose of an EPS file is to be included in other pages. Sometimes EPS files are called EPSF files. EPSF simply stands for Encapsulated PostScript Format. An EPS file can contain any combination of text, graphics and images. Since it is actually a PostScript file, it is the most versatile file format that is available. To avoid the need for a PostScript interpreter, EPS-files usually contain a small preview image that is used to visualize its content. EPS files can be generated by all drawing applications as well as most layout applications. Image manipulation programs such as Adobe PhotoShop, manufactured by Adobe of San Jose, Calif., can also save bitmap images as EPS-files. Some printer drivers are also capable of generating EPS-files as well as PostScript files.

Various types of templates are created for print images, choice images, web images, and web color images. The templates are created using the color white. The EPS format is changed into PSD Photoshop. PSD is an acronym for Photo Shop Drawing. The dimensions of the images are changed to conform to the specific size of the template. The images are created based on the template measurements. Next, there is a reduction of 22 pixels to the image's original size to insert a white stroke to each image plus 1 pixel to create the image cutting line. Each image is saved in the Portable Networks Graphic (PNG) format with its respective name. The PNG format was designed to replace the older and simpler GIF format and, to some extent, the much more complex TIFF format. Both the GIF and TIFF formats are well known in the art

The process is continued, as depicted in FIG. 15C, by saving each image in a specific folder. Each folder is checked to make sure its content is correct (image versus name of folder). If there is an error, the type of error should be verified and corrected. It is recommended that a system is used that verifies the name of the folder, rather than the name of the image. It is recommended that an additional error check be performed.

A Microsoft Excel® file is created with the complete image structure for the School, as depicted in FIG. 15D. Copies are made of the templates for skin and animation elaborations. The file is upload to an FTP site with the complete structure.

Order Submission and Fulfillment

There are a few components in the inventive system to integrate with the order fulfillment factories' servers. In the preferred embodiment, some servers are hosted in the United States and others are hosted offshore. Those in the United States are to serve data to consumers. One server is the web server and the other is a database which communicates with the web server. In the preferred embodiment, this setup is mirrored in offshore, and contain the substantially the same data as in the U.S. server. The database in the United States contains web-ready artwork. Web-ready artwork is low resolution art specifically used for showing the customer what they are ordering. The offshore database contains print-ready artwork which is a much higher resolution version of the art. This print-ready artwork is used when the actual products are created.

Additional details of the queue processes depicted in FIG. 6C through 6E are described below. When an order is placed it is not immediately sent to the offshore server. Rather, a process which runs intermittently sends orders at appropriate times. If the connection is lost, the orders will not be. A similar queue is setup in the domestic factory which monitors the submission of orders to the domestically-hosted system.

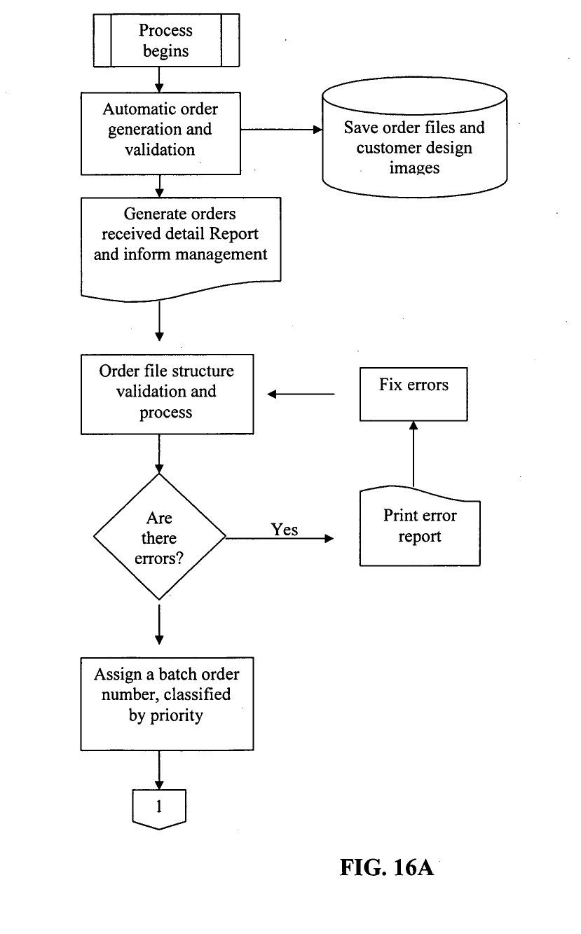

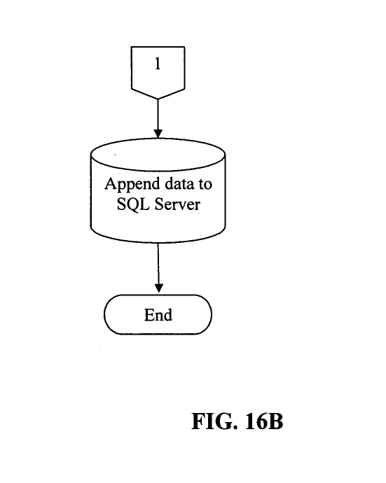

As illustrated in FIG. 16A, the submission of the orders begins with automatic order generation and validation. This step consists of generating and downloading the order file containing all sites orders information from a manager internet site. The custom design images for each order are also generated and downloaded into a file archive, such as a ZIP file in which the files are compressed. Once the orders are received, reports containing all details for the order (e.g. name, address, product type, and others) are sent via electronic mail to factory management. To check for errors, a system is used that validates, processes, and prints custom design images. An example of such a system is ALFA.

If any errors exist, the Information Systems Department fixes the error and sends an error report about to an Information System manager. When orders are processed successfully, the next step is to assign orders to a batch, as set forth at the bottom of FIG. 16A, classifying each order by priority. The data is saved in a database management server such as Microsoft SQL Server by the Microsoft Corporation of Redmond, Wash. to distribute on any and all computers connected to the database. This step is illustrated in FIG. 16B.

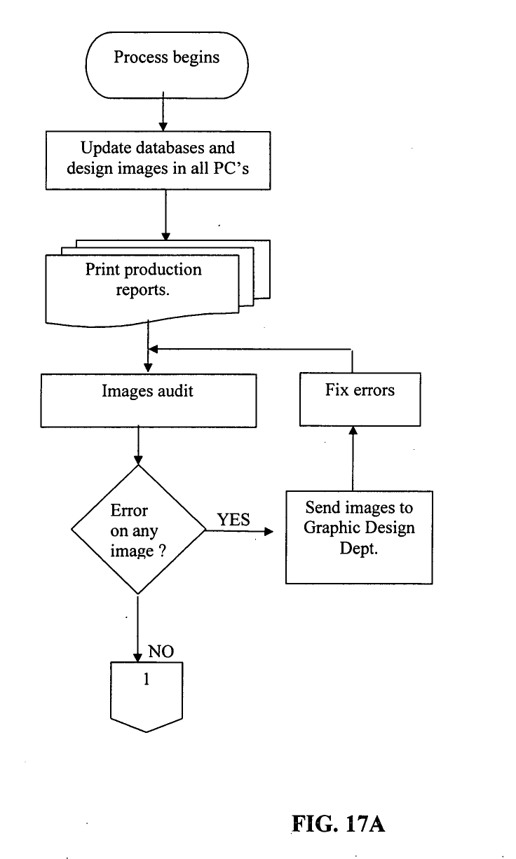

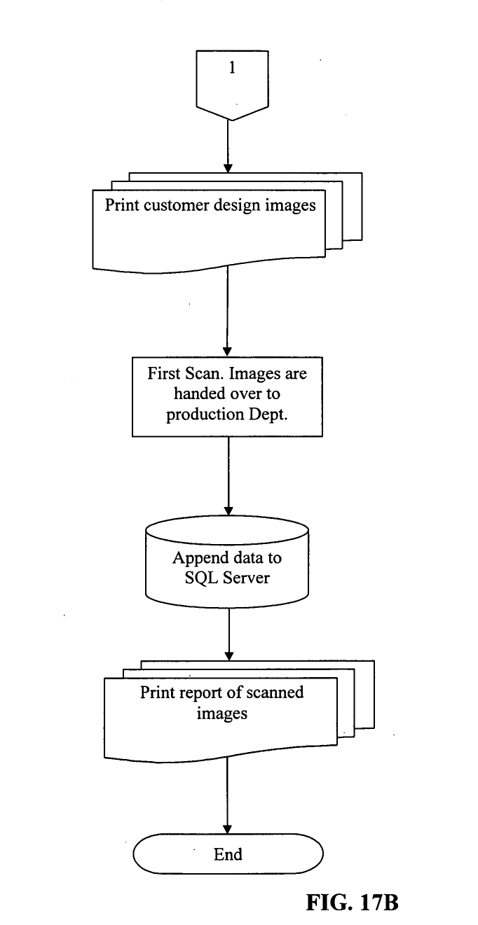

The process of the present invention of printing the customized design images is illustrated in FIGS. 17A and 17B. The design images are downloaded from the server. System operators update in each computer all data and design images for each batch that is processed. All reference information of each order (i.e. the characteristics of each order) is submitted for production. The images are audited for the existence of errors. If there are errors on any image, the images are forwarded to a Graphic Design Department for correction. The correction images are then returned to the printing process. Each customer design image is printed, as illustrated in FIG. 17B, with the respective characteristics that correspond to it, for example: size, color, product, using a printer such as the Epson Technology Stylus Pro 4000®, manufactured by the Seiko Epson Corporation of Pagano, Japan. A first scan of each of the orders is performed. The data is saved in Microsoft SQL Server for distribution to all computers connected to the database. A report of the scanned images is printed, and is used to control production and tracking of the order in the factory.

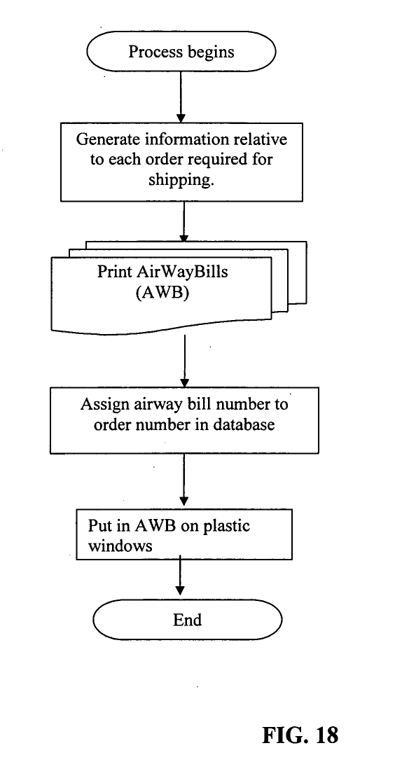

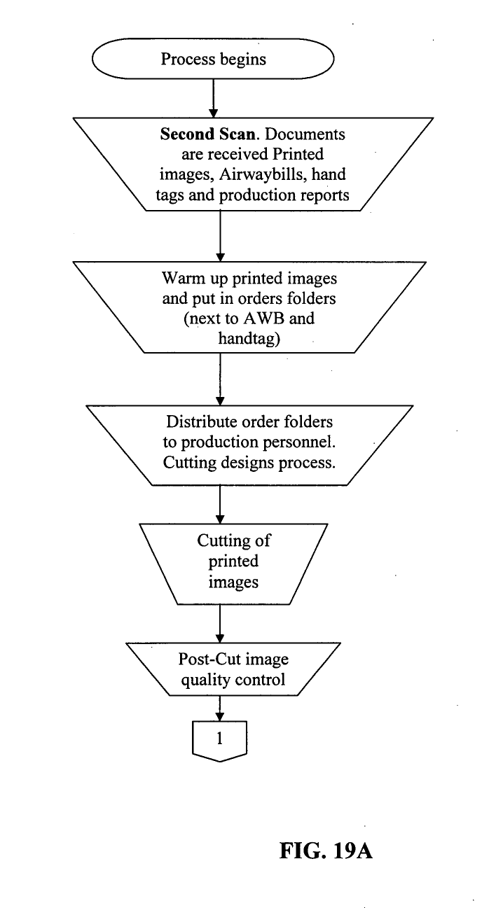

Once the images are printed, the package for transporting the final customized images design product is prepared. This process is depicted in FIG. 18. In the preferred embodiment, this process occurs before the curing and cutting of the design images. Referring back to FIG. 18, International Air Transport Association (IATA) codes containing airline designators, location identifiers and accounting and prefix codes for the transport documents are generated for an airway bill (AWB) document. The name and address of the client and shipment details are also included in the AWB. The information in the AWB is printed. The AWB number assigned to each order is recorded for future reference. Multiple copies of the AWB are placed into a plastic bag.

Ink Curing

The present invention further comprises a process for minimizing the time it takes to complete an order by curing or dehydrating the ink on freshly printed images in a heater/dehumidifier. By warming freshly printed pages at temperatures that do not cause the transfer paper to change its current state, the drying time necessary for the ink to cure onto the transfer paper is decreased. This curing process is important because it prevents the images from smudging during the transfer process. By using this method, reduction of order production time results in reduced cost and greater image quality.

Image Cutting:

It is beneficial to have as little “paper” transferred with a given image onto a product as possible. The reference to “paper”, is meant to include all non-colored or non-designed printed components that accompany the final customized design image from the printer. Therefore, the present invention further comprises a process to perform the manual cutting of images with extreme accuracy. Each image, text, or graphic that is selected, typed or uploaded by a customer receives an outline or “stroke” not more than approximately 100 pixels away from the border of said image, text or graphic. This outline is not visible to the customer on the web site but is created and printed at the factory in order for the cutters to create a uniform cut line around each image, text or graphic at approximately the same distance from all points on the border of said image, text or graphic.

In the preferred embodiment, an outline is created not more than 7 pixels away from the border of each image, text or graphic. This outline also allows cutters to work at a faster pace and with fewer mistakes thereby reducing the time and cost it takes to produce and order. The result is a higher quality product with and higher perceived value to the end customer at a significantly lower cost to the manufacturer.

During the cutting process, it is relevant to mention that the cutting process is conducted on customized “light boards” where the paper with the image, text, or graphic is placed on a sheet of transparent or translucent material and a light source is directed from below this transparent or translucent material to enhance the visual different between where the ink exists on the paper and where the ink does not exists. Using the customized “light board” allows for a faster and more accurate cutting process which increases product quality and decreases product cost. A light table is a table or bench having translucent top over a light source. It is used in examining objects where it is desired that no shadow will be cast.

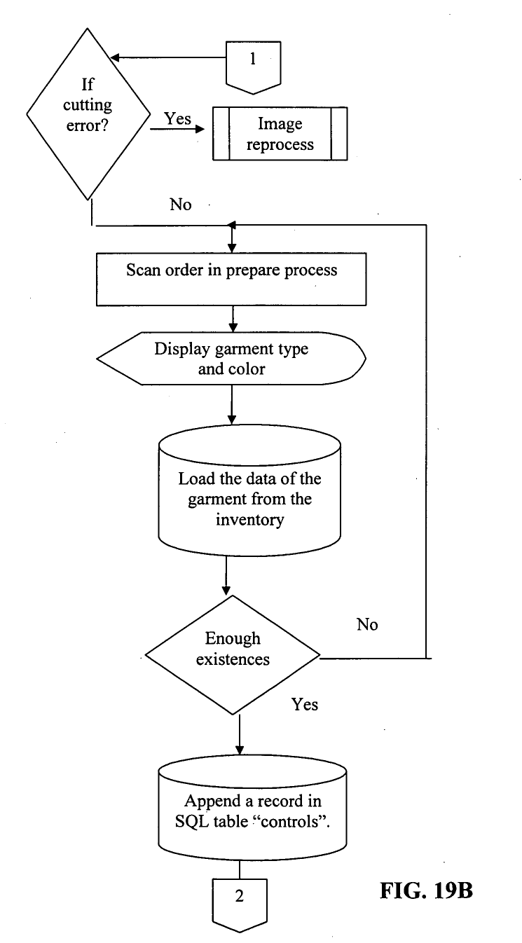

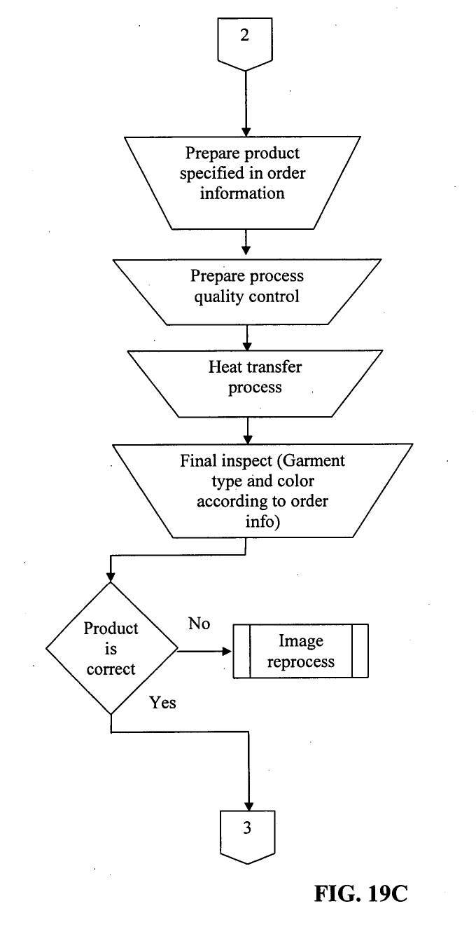

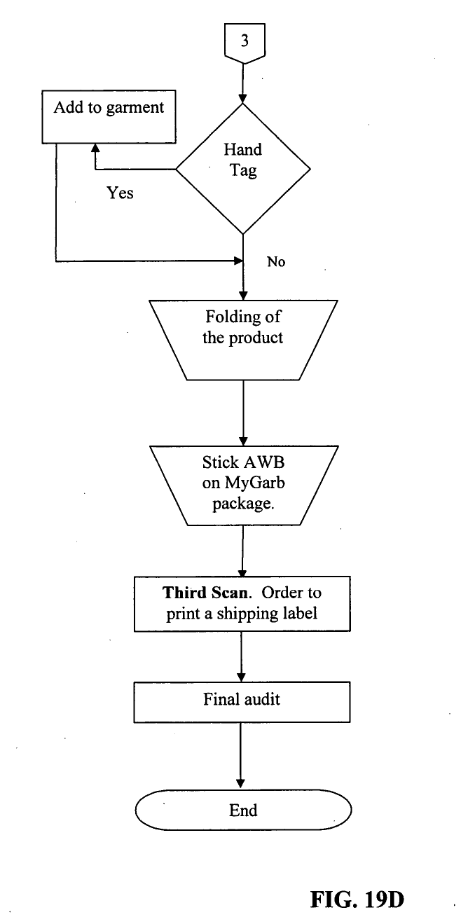

This process is specified in further detail in FIGS. 19A through 19D. A second scan of the printed images and accompanying transport documents is performed. A scan of the hand tags to be placed on the product is also performed. The printed images are to be warmed on normal transfer paper and distributed to respective order-related folders. Once the folders with printed images are completed, they are distributed to production personnel. The entire contour of each image is cut, leaving only the necessary area for the transfer process. The images are inspected for quality control. If an error is detected, an alert is sent and the image is re-printed and the curing and cutting processes are repeated.

In FIG. 19B, all the information required to process the product as size, type of product, color is displayed. Inventory data for the garment is also displayed. If there is enough existence on the inventory for the discharge of the garment, a register is added. If not, the system is advised to start a charge in the inventory of the garment. A record in a SQL table “control.” is appended with all the data of the garment that will be discharged from the inventory.

Referring to FIG. 19C, the production personnel take the garment required for the order based on the type of product, size and color (e.g. men's T-shirt in medium, color white). A process quality control is performed in which the printed information in the detail of the image is compared with the real product and the characteristics. The heat transfer is applied to the product. The transfer of the image to the product selected by the client undergoes an audit. If the product is not accepted, an image reprocess is commenced, as depicted in FIG. 19C.

A check for the requirements of hand tags on the product is performed. This is for license requirements depending on the customer. If a hand tag is required, it is added to the product. This step is depicted in FIG. 19D. The final product is packaged in shipping bags. Referring back to the AWB prepared in the process depicted in FIG. 18, the prepared AWB is placed onto the shipping bag. Shipping labels are printed with the destination data of the purchaser. A final audit of the customized design apparel or product is performed.

Shipping Conservation

Because each item in a customer's order is individually made and personalized, the situation arises where one product in an order can be sent prior to another. In the preferred embodiment, the customer is presented with the opportunity to have the factory hold all products at the factory to be shipped in one container when all items are completed and ready to ship. This saves cost and material, which is good for the customer, the factory, and the environment. In the event that a customer would like the items to be sent as they are completed, they may select that option at additional cost. The shipping conservation method described herein is well known in the art. However the combination of this method with the inventive processes and technology described above serves to comprise the novel and non-obvious system that is set forth herein.

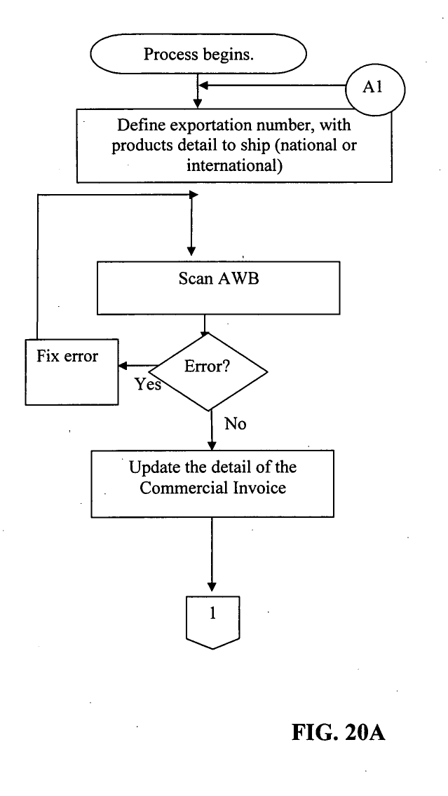

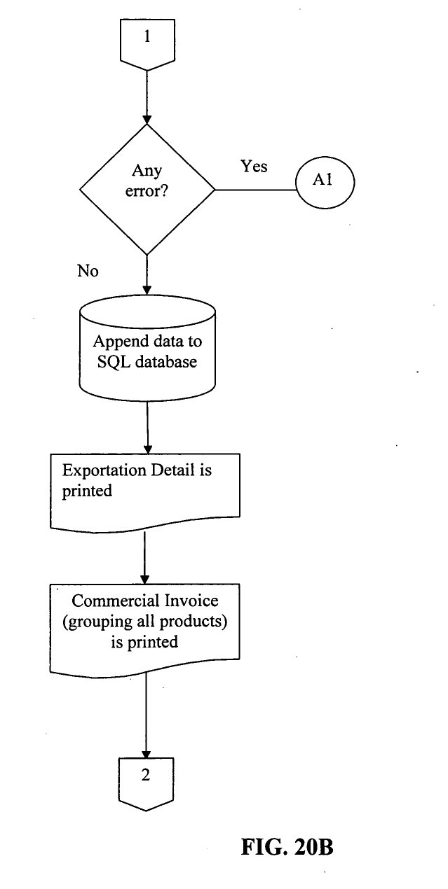

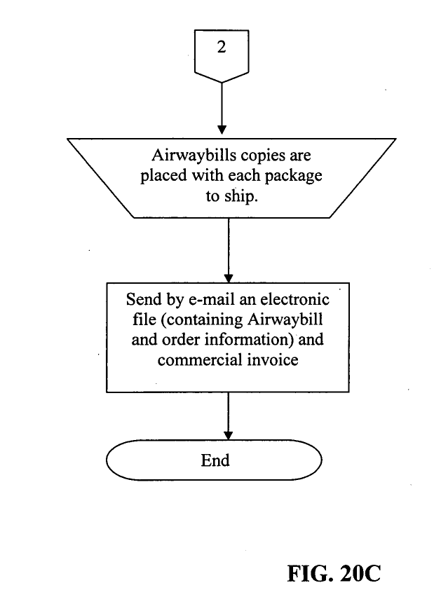

FIGS. 20A through 20C depict the shipping conservation process in detail. All orders to be shipped are updated to database with the detail of quantity, total cost and other pertinent information. The ABW is scanned in order to register the garment for export or transport. If any error exists, the error is corrected and the AWB is rescanned. Detail of exportation is updated to the commercial invoice. A second error check is performed. All information is appended to SQL database for future reference. Exportation detail is printed and stored. In the preferred embodiment, three copies of the commercial invoice are printed—1 for Courier Company, 1 for Import/export department and 1 to be kept as back up printed report. AWB copies for a selected courier Company are placed into the package with the orders products. The products are shipped.

Referring to FIG. 20C, an email is sent to the courier. In this e-mail is attached an electronic file containing Airway bill and order information. Also is attached a commercial invoice file containing the total of the products.

It will be readily apparent to those skilled in the art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

1. A system for the customized design of apparel and merchandise, said system comprising:
(a) a website for the customization of apparel and merchandise image designs;
(b) a user accessing the website remotely through an internet connection;
(c) at least one screen interface on the website for the customization of apparel and merchandise image designs by the user;
(d) a library comprising a database containing a plurality of pre-designed images;
(e) at least one design tab on the at least one screen interface for selection by the user for the creation of customized design;
(f) at least one design layer included within the at least one screen interface;
(g) a host database providing storage of data pertaining to the customized apparel and merchandise designs; and
(h) a remote database providing storage of data pertaining to the customized apparel and merchandise designs;

2. The system of claim 1, wherein the website may be a client-branded website for the design customization of team, organization, school or university apparel and products.

3. The system of claim 1, wherein the website may be a business-to-business website for the design customization of apparel and merchandise.

4. The system of claim 1, wherein the at least one screen interface includes text formatting options.

5. The system of claim 1, wherein the at least one design tab provides access to basic design, advanced design, product selection, product assembly, art selection, addition of product to check out cart, and purchase.

6. The system of claim 1, wherein the at least one design layer provides access to logos, team position, title, class year, and ready-made suggestions.

7. A system for the customized design of apparel and merchandise, said system comprising:
(a) a website for the customization of apparel and merchandise image designs;
(b) a user accessing the website remotely through an internet connection;
(c) at least one screen interface on the website for the customization of apparel and merchandise image designs by the user;
(d) at least one design tab on the at least one screen interface for selection by the user for the creation of customized design;
(e) at least one design layer included within the at least one screen interface;
(f) a remote server having images of user-customized images for uploading;
(g) a host database for the storage of data pertaining to the customized apparel and merchandise designs; and
(h) a remote database for the storage of data pertaining to the customized apparel and merchandise designs;

8. The system of claim 7, wherein the website may be a client-branded website for the design customization of team, organization, school or university apparel and merchandise.

9. The system of claim 7, wherein the website may be a business-to-business website for the design customization of apparel and merchandise.

10. The system of claim 7, wherein the at least one screen interface includes text formatting options.

11. The system of claim 7, wherein the at least one design tab may be for basic design, advanced design, product selection, product assembly, art selection, addition of product to check out cart, and purchase.

12. The system of claim 7, wherein the at least one design layer may be for logos, team position, title, class year, and ready-made suggestions.

13. A system for the fulfillment of customized design apparel and merchandise orders, said system comprising:
(a) at least one record of an order of a customized product design;
(b) an order queue for the linking of at least one order record;
(c) a web-ready image of the customized product design;
(d) a URL link of the web-ready image;
(e) a host database having at least one order record;
(f) a remote database having at least one order record; and
(g) a processing batch having at least one order record.

14. A method for the customized design of apparel and merchandise, said method comprising:
(h) accessing of a website for the customized design of apparel and merchandise by the user;
(i) selecting a desired product for customized design;
(j) selecting an image template from a designated database library;
(k) optionally uploading an image from a remote server;
(l) selecting a design layer;
(m) adding text to the selected or uploaded image template or image to create a customized design product;
(n) accepting the customized design product;
(O) displaying the at least one view of the customized design product; and
(p) ordering the customized design product.

15. The method of claim 14, wherein the desired products are apparel comprising t-shirts, sweatshirts, crew neck shirts and camisoles.

16. The method of claim 14, wherein the desired products are merchandise comprising coffee mugs, bags, mouse pads, towels, water bottles, stickers, coffee mugs, and cards.

17. The method of claim 14, wherein the at least one view of the customized design product may be views of the front and back of the product.

18. A method for the fulfillment of customized design apparel and merchandise orders, said method comprising:
(a) verifying ordering information provided by a user for the purchase of a customized product design;
(b) sending a record of an order to a host database;
(c) linking the order record into an order queue;
(d) preparing a web-ready image of the customized product design;
(e) uploading the web-ready image to a host database;
(f) creating a URL link to the web-ready image;
(g) embedding the URL link into an electronic mail message;
(h) sending the electronic mail message to the user;
(i) retrieving the order record from the order queue;
(j) sending the order record to at least one remote database;
(k) directing the order record to a file server;
(l) placing the order into a processing batch;
(m) completing processing of the batch; and
(n) shipping the order to the user.

19. A method for positioning image text on customized apparel and merchandise designs, said method comprising:
(a) enlarging customized product images and text to substantially occupy a printing area;
(b) adding subsequent customized product images and text to the printing area; and
(c) proportionately downsizing the previously added customized product images and text to accommodate the subsequently added customized product images and text in the printing area.

20. The method of claim 19, wherein the customized product images are of apparel or merchandise designs.

21. The method of claim 19, wherein the printing area may be of variable dimensions.

22. The method of claim 19, wherein the proportional downsizing may include resizing and repositioning of the customized product images and text.

23. A method for the pixilation of customized apparel and merchandise designs, said method comprising:
(a) adding a substantially box-shaped border to at least one customized product design image to create at least one contoured image;
(b) displaying the at least one contoured image in at least one layer;
(c) maintaining the quality of the at least one contoured image within the at least one layer; and
(d) optionally dithering the at least one contoured image.

24. The method of claim 23, wherein the customized product images are of apparel or merchandise designs.

25. A method for the fulfillment of customized design apparel and merchandise orders, said method comprising:
(a) generating and downloading an order file;
(b) generating and downloading customized product design images associated with an order file;
(c) generating order reports;
(d) sending the order reports to a designated location;
(e) performing an error check of the order reports;
(f) assigning at least one order file to a batch;
(g) classifying the at least one order file by priority;
(h) sending the electronic mail message to the user;
(i) auditing the customized product design images;
(j) printing the customized product design images;
(k) performing a first scan of the customized product design images;
(l) preparing transport documents for the shipping of a completed customized product design;
(m) curing the customized product design images;
(n) cutting the customized product design images;
(o) transferring the customized product design image to a user-selected product to create the completed customized product design;
(p) optionally adding hand tags to the completed customized product design; and
(q) performing a process quality control.

26. The method of claim 25, wherein the customized product images are of apparel or merchandise designs.
